(19) United States
(12) Patent Application Publication
(10) Pub. No.: US 2006/0014299 A1
(43) Pub. Date: Jan. 19, 2006

(54) Method for analyzing blood for cholesterol components

(76) Inventor: Jan M. Troup, The Woodlands, TX (US)

Correspondence Address: ROBERT W STROZIER, P.L.L.C, PO BOX 429, BELLAIRE, TX, 77402-0429, US

(21) Appl. No.: 11/104,285

(22) Filed: Apr. 12, 2005

Related U.S. Application Data
(60) Provisional application No. 60/561,463, filed on Apr. 12, 2004.

(51) Int. Cl. G01N 1/18; G01N 21/76

(52) U.S. Cl. 436/177; 436/172

(57) ABSTRACT

A method for detecting and quantifying lipoprotein subgroup concentration in a blood serum sample in a single spin cycle using a fluorescent dye and a self generating continuous gradient followed fluorescent dye detection and quantitation.

### RELATED APPLICATIONS

This application claims provisional patent priority to U.S. Provisional Patent Application Ser. No. 60/561,463, filed Apr. 12, 2004.

### BACKGROUND OF THE INVENTION

1. Field of the Invention

The present invention relates to a method and apparatus for analyzing cholesterol components in blood of an animal including a human.

More particularly, the present invention relates to a method and apparatus for analyzing cholesterol components in blood of an animal including a human, where the method includes the step mixing a serum sample with a fluorescent dye and self generating gradient material, developing an analyzable mixture in a centrifuge tube under increased gravity via application of external centrifugal force and analyzing the resulting developed mixture to generate a detailed cholesterol component analysis.

2. Description of the Related Art

Human blood serum contains lipoproteins whose values are traditionally determined by a lipid panel and used by physicians to diagnosis and treat patients for cardiovascular disease. The National Cholesterol Education Program (NCEP) acknowledges that 50% of the people with cardiovascular disease are missed by the standard lipid panel tests for total cholesterol, triglycerides, HDL and calculates LDL. NCEP described in the latest ATP III (Adult Treatment Program III) guidelines, new emerging risk factors that are important in the diagnosis and treatment of those people missed by the standard lipid panel. NCEP does not generally recommend analysis of the new emerging risk factors due to the lack of availability and the cost of these tests. None the less a number of companies have emerged to address this need and supply information on these risk factors.

A number of methods have been developed as cost and time saving alternatives to the CDC method of cholesterol analysis to provide information on the new lipoprotein risk factors as identified in the NCEP guidelines for the diagnosis and treatment of people at risk of cardiovascular disease. Historically, the CDC method using gradient separation of the lipoproteins in the blood by analytical ultra centrifugation is know as the gold standard in identifying the lipoprotein classes of VLDL, LDL and HDL. The CDC method, however does not break down lipoproteins into subgroups which are necessary for the identification of the new emerging risk factors. To extend the CDC method with sequential multiple gradient separations of subgroups is very time consuming and expensive. In view of these problems other methods have been developed to give information that approximates an extended CDC sequential separation with techniques that are faster and/or less costly than the CDC method.

Known literature and/or patented methods for analyzing lipoproteins are:
1. A Texas A&M patent on a series of self generating gradients, U.S. Pat. No. 6,593,145.
2. A Texas A&M patent application on the lipoprotein profiling process using the patented gradients. This process starts out the same as the LipidLabs process with the blood serum, gradient and fluorescent dye being added to a centrifuge tube and spun for a number of hours to form a gradient. The stained, separated lipoproteins form layers in the tube based on VLDL, LDL, HDL and proteins. The profile is obtained by photographing the tube using filters to obtain only the fluorescence and plotted as intensity versus density. Fractions can be collected by the freeze/thaw method where the centrifuge tube is frozen and then sliced to recover a band and thawed.
3. Methods of extracting the contents of a centrifuge tube are being used by a competitor and others in the industry. This usually involves puncturing the bottom of the tube with a needle and pumping out the contents. Also, Brandel makes a pump to extract the contents of a centrifuge tube with a plunger. LipidLabs uses this pump for our process.
4. Atherotech, a competitor, extract the contents of a centrifuge tube with a needle in the bottom and pumps the contents into a reactor that converts all of the lipoproteins into cholesterol and develops a color which is measured by an absorption photometer. I don't know of anyone using a fluorescence detector in this application.
5. Finger stick collection can be used for cholesterol analysis but advanced test and subgroup analysis require more serum than produced by finger stick. A heparin anti-coagulant is the one of choice for finger stick blood collection.
6. Blood serum must be frozen below −70 C to preserve the lipoproteins.
7. The dye color intensity response, measured by a photometer, from lipoproteins varies depending on the lipoprotein and subgroup.

Thus, there is a need in the art for an improved cost effective method for determining lipoprotein subgroups.

### SUMMARY OF THE INVENTION

The present invention provides a method including the steps of:
collecting a blood sample via a venous draw into red top tubes with no anticoagulant or via a finger stick technology using an EDTA anticoagulant;
separating the serum, where the amount of serum needed for the test is less than 20 μL, but greater amounts can be use as well;
mixing the serum with a fluorescent dye and a self generating gradient material to form an analyzable mixture in a centrifuge tube;
incubating the mixture at a temperature and for a time sufficient to facilitate uptake of the dye;
spinning the mixture at a temperature, at a spin rate and for a time sufficient to obtain a desired degree of separation of lipoproteins in the serum;
a short time before the end of the spinning step, stopping a rotor and adding a layer of water on top of the mixture to facilitate the separation of IDL and VLDL subgroups;
after the spinning step, storing the sample in the centrifuge tube in a substantially vertical orientation for a relatively short period of time and at a low temperature sufficient to stabilize the sample;
a short period of time after the storing step, extracting the contents of the centrifuge tube with a plunger device having a hole in a center of the plunger; and
pushing the plunger contents into a fluorescence detector and pumping the last amount with an HPLC pump, where the detector is calibrated and its setting adjusted to emission and absorbance wavelengths of the dye to obtain lipoprotein subgroup data.

The present invention also provides a method including the steps of:
collecting a blood sample via a venous draw into red top tubes with no anticoagulant or via a finger stick technology using an EDTA anticoagulant;
separating the serum, where the amount of serum needed for the test is less than 20 μL, but greater amounts can be use as well;
mixing the serum with a fluorescent dye and a self generating gradient material to form an analyzable mixture in a centrifuge tube;
incubating the mixture at a temperature and for a time sufficient to facilitate uptake of the dye;
spinning the mixture at a temperature, at a spin rate and for a time sufficient to obtain a desired degree of separation of lipoproteins in the serum;
a short time before the end of the spinning step, stopping a rotor and adding a layer of water on top of the mixture to facilitate the separation of IDL and VLDL subgroups;
after the spinning step, storing the sample in the centrifuge tube in a substantially vertical orientation for a relatively short period of time and at a low temperature sufficient to stabilize the sample;
a short period of time after the storing step, extracting the contents of the centrifuge tube with a plunger device having a hole in a center of the plunger;
pushing the plunger contents into a fluorescence detector and pumping the last amount with an HPLC pump, where the detector is calibrated and its setting adjusted to emission and absorbance wavelengths of the dye;
correcting the resulting digital profile data for start position and first signal;
normalizing the data with a SAVR correction routine; and
converting the corrected and normalized data from a time scale to a pre-calibrated density scale.

The present invention also provides a method including the steps of:
collecting a blood sample via a venous draw into red top tubes with no anticoagulant or via a finger stick technology using an EDTA anticoagulant;
separating the serum, where the amount of serum needed for the test is less than 20 μL, but greater amounts can be use as well;
mixing the serum with a fluorescent dye and a self generating gradient material to form an analyzable mixture in a centrifuge tube;
incubating the mixture at a temperature and for a time sufficient to facilitate uptake of the dye;
spinning the mixture at a temperature, at a spin rate and for a time sufficient to obtain a desired degree of separation of lipoproteins in the serum;
a short time before the end of the spinning step, stopping a rotor and adding a layer of water on top of the mixture to facilitate the separation of IDL and VLDL subgroups;
after the spinning step, storing the sample in the centrifuge tube in a substantially vertical orientation for a relatively short period of time and at a low temperature sufficient to stabilize the sample;
a short period of time after the storing step, extracting the contents of the centrifuge tube with a plunger device having a hole in a center of the plunger;
pushing the plunger contents into a fluorescence detector and pumping the last amount with an HPLC pump, where the detector is calibrated and its setting adjusted to emission and absorbance wavelengths of the dye;
correcting the resulting digital profile data for start position and first signal;
normalizing the data with a SAVR correction routine;
converting the corrected and normalized data from a time scale to a pre-calibrated density scale;
fitting the corrected and normalized density scale data with about 20 Gaussian functions at specific densities to get integrated data on a cholesterol mg/dl scale for the various lipoprotein subgroups; and
transferring the profile of cholesterol versus density and the subgroup concentration and density data into a spread sheet program to produce the final report.

The present invention provides a lipoprotein separated serum sample in a self generating continuous gradient, where the lipoprotein subgroups are separated for later detection and quantitation.

The present invention also provides a lipoprotein profile derived from a serum sample of a human.

### DETAILED DESCRIPTION OF THE INVENTION

The inventors have found that at new lipoprotein analysis procedure based on the CDC gold standard, analytical ultra centrifugation, having dramatically reduced the time and cost to obtain a result with a self generating continuous gradient can be constructed and successfully implemented. The advantage of this new technology is that all of the lipoproteins can be separated in a single spin in a number of hours rather than days required by the extended CDC method. Furthermore, the continuous gradient profile can be divided into slices by density to give accurate concentration reading of all lipoprotein subgroups at their specific densities. This lipoprotein subgroup information is the component needed to produce accurate information and data on all of the emerging new lipoprotein risk factors identified by the NCEP. This allows the present procedure to use the CDC gold standard, analytical ultra centrifugation separation technology rather than an approximation technology while allowing the technology to be extended to encompass determination of newly identified lipoprotein subgroups rendering accurate lipoprotein subgroup information.

The method of this invention includes the following steps:
collecting a blood sample via a venous draw into red top tubes with no anticoagulant or via a finger stick technology using an EDTA anticoagulant;
separating the serum, where the amount of serum needed for the test is less than 20 μL, but greater amounts can be use as well;
mixing the serum with a fluorescent dye and a self generating gradient material to form an analyzable mixture;
incubating the mixture at a temperature and for a time sufficient to facilitate uptake of the dye;
spinning the mixture at a temperature between 4° C. and 20° C., where a temperature between about 4° C. and about 10° C. is preferred, and a temperature between about 4° C. being particularly preferred. The time and speed of the spin are interdependent. Either a long spin time of about 12 to about 24 hours, with 17 hours being a preferred spin time at a spin rate between about about 80,000 and about 90,000 rpms, with a spin rate of about 85,000 rpms being preferred (about 250,000 g's). Also, a shorter spin time of about 5 to about 7 hours at a spin rate of about 120,000 rpms (over 600,000 g's) produces a similar result. One hour before the end of the spin, the rotor is stopped and a layer of water is added on top of the mixture for the separation of IDL and VLDL subgroups;
after the spinning step, storing the sample in a substantially vertical orientation for a period of time less than about two hours at a temperature between about 2° C. and about 8° C.;
shortly, preferably immediately, after the storing step, extracting the contents of the centrifuge tube with a plunger device having a hole in a center of the plunger. A plunger device available from Brandel is suitable.
pushing the plunger contents into a fluorescence detector except for the last amount which is pushed out of the plunger with an HPLC pump. The detector is calibrated and its setting adjusted to emission and absorbance wavelengths of the dye;
correcting the resulting digital profile data for start position and first signal;
normalizing the data with a SAVR correction routine;
converting the corrected and normalized data from a time scale to a pre-calibrated density scale;
fitting the corrected and normalized density scale data with about 20 Gaussian functions at specific densities to get integrated data on a cholesterol mg/dl scale for the various lipoprotein subgroups; and
transferring the profile of cholesterol versus density and the subgroup concentration and density data into a spread sheet program to produce the final report.

Alternatively, the tube could be photographed as a measure of the fluorescence like the Texas A&M method or alternatively a tuned light source and a wavelength selectable proximity detector could be used to detect the fluorescence.

The separated sample can be collected in a fraction collector for post separation analysis by other methods, if necessary. In addition the sample can be pushed through an HPLC separation column using size exclusion or other packing prior to going into the fluorescence detector to further separate the lipoprotein subgroups.

An absorbance detector can also be used alone or in conjunction with the fluorescence detector to examine other features or markers of the separated sample not detected by fluorescence.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

What is a new innovation in lipoprotein testing as developed by Jan M. Troup and may be claims in the patent:

Finger stick technology must be done carefully to avoid changing the lipoproteins. If a sample is obtained by medium to heavy messaging of the finger to get enough blood the HDL peak in the profile becomes much more buoyant and moves out of the theoretical range for HDL, less than 1.063 g/cm³. Since HDL is a scavenger of lipids and since proteins are heavier than HDL about the only possibility is that the HDL must pick up free lipids generated by the aggressive activity. So the blood collection should only be done when the blood is freely flowing with minimal pressure applied to the finger to obtain the sample. The shift of the HDL is also seen when hemolysis is present in the sample and can be caused by not using an anti-coagulant. If a clot activator tube is used this causes hemolysis and an HDL shift. The use of heparin treated collection tubes or capillaries will cause the VLDL and some of the LDL to delipidate. This effect is clearly seen as a major reduction in the VLDL and LDL peaks and an increase in the protein peak. The only anti-coagulant that has been found to provide good profiles is EDTA, either as treated collection tubes or capillaries.

The process preserves the sample, and fractions or subgroup can be collected in a fraction collector. The process involves pumping the contents out of the tube in way that will allow an HPLC pump to pump the content through a size exclusion or other column for further separation of the lipoprotein subgroups and then on to the fluorescence detector and sample collector. This method of extraction of pre-separated lipoprotein by ultracentrifugation and possible additional separation by HPLC (not yet tried) and then measurement without destruction of the lipoproteins. I don't think is known technology.

Many experimental variables: i.e. Incubation of the sample mixture; the temperature of the spin (4 degrees C.); holding the samples after the spin; the speed of sample extraction; the use of a smaller centrifuge tube than A&M's; and other variables all give rise to a better result.

The gradient Na Bi EDTA which is now being used by Texas A&M and me separates the VLDL, LDL, HDL very well but the gradient starts at a density of about 1.020 g/cm³. This means that all of the VLDL subgroups and IDL which make up the important emerging new risk factor RLP or remnant lipoprotein are at the top of the tube and not separated. To solve this I had an idea of adding a water layer on top of the tube (60 μl on top of 520 μl of gradient) during the last one hour of the spin. The water slowly diffuses into the gradient and the lipoproteins find their proper density between 1.000 and 1.020 and are clearly separated. Others have used the addition of a layer of different density for separation but I don't think the technique has been used to extend a gradient to form a continuous gradient from 1.000 to 1.3+g/cm³. Reaching a low density at the same time generating a density of 1.3 g/cm³ has probably not been done before.

Since the color or fluorescence of the dye varies depending on the lipoproteins and subgroup, and the separated lipoproteins need to be on a common cholesterol scale, an algorithm was developed based on the theory that the surface dying of the particles is controlled by the size/volume relationship of the particles. The algorithm called SAVR for surface area volume relationship is empirically determined but the initial values were very close to the calculated values of the size/surface area from know measured size data. Another factor that controls the dye uptake is the amount of phospholipids on the surface of the lipoprotein particles. The surface amount of phospholipids is not exactly known by subgroups. The NBD fluorescent dye being used is NBD C6 Ceramide and is a phospholipid analog and attaches to this part of the lipoprotein particle. Therefore the correction or SAVR function being applied to the raw data is empirically adjusted to fit the determined cholesterol values and put the entire profile on the same cholesterol scale. This has never been done before to my knowledge. In addition, if the dye is changed to Nile Red, for example, the function can be adjusted for the specific emission response of the different dye.

The corrected profile, on a common cholesterol scale, can then be fitted with about twenty Gaussians functions at literature density values for the known lipoprotein subclasses to generate populations and concentrations of each of the subgroups. This separation is necessary to identify the emerging risk factors identified by NCEP. Others have used Gaussians for subgroup determination but only after converting the lipoproteins to raw cholesterol which destroys the lipoproteins. By preserving the lipoproteins, post analysis is possible using other techniques to further analyze them. This will be important in the future where the identification of apolipoproteins will be needed for a more advanced test.

It has been discovered that freezing blood serum or plasma at −70° C. or lower, damages the lipoproteins in unpredictable ways. After careful calibration of the process with carefully analyzed fresh serum using enzymatic methods, standards/calibrators were tested and found to have large discrepancies from the assigned values. Further tests analyzing fresh serum and then freezing the serum at −80 degrees C. showed changes that vary from person to person. The VLDL area is usually greatly reduced (10-80%), the LDL area usually is moderately reduced (0-30%) and the HDL area is usually increased (0-30%) in unpredictable ways. This means that frozen serum can not be used for calibration; therefore fresh serum that is analyzed using other methods is used to calibrate the process and then frozen serum, now stabilized, can be given assigned values as calibrators. Unfortunately this means using a secondary standard but fresh serum calibrators are not commercially available. Some luck has been achieved by mixing fresh serum with the dye and gradient and then freezing the mixture. After freezing for several weeks it has been determined that the VLDL has reduced but the LDL and HDL area remained unchanged. This is ongoing research. It is not known in the industry that LDL and HDL particles are affected by freezing but it is suspected that VLDL might be affected. My belief is that the freezing creates a crystalline water lattice in the particles that breaks up the particles. The use of the gradient is maybe a cryo preservant that keeps the water in a glass phase rather than crystalline.

A report format with the calculation of a number of parameters has been prepared that should be protected by the copyright. One new parameter is calculated to help physicians quickly determine how to treat patients without having to digest all of the various flags associated with a dense LDL profile. The parameter is called LDL(D) is a recalculated LDL value that incorporates the additional lipoprotein particles present from dense LDL III and IV and reflects these additional particles present as an adjusted LDL mg/dl number. The physician should use this number in the same way they use the LDL number for diagnosis knowing that it now represents the fact that dense LDL maybe present above normal levels.

We claim:

1. A method including the steps of:
collecting a blood sample via a venous draw into red top tubes with no anticoagulant or via a finger stick technology using an EDTA anticoagulant;
separating the serum, where the amount of serum needed for the test is less than 20 μL, but greater amounts can be use as well;
mixing the serum with a fluorescent dye and a self generating gradient material to form an analyzable mixture in a centrifuge tube;
incubating the mixture at a temperature and for a time sufficient to facilitate uptake of the dye;
spinning the mixture at a temperature, at a spin rate and for a time sufficient to obtain a desired degree of separation of lipoproteins in the serum;
a short time before the end of the spinning step, stopping a rotor and adding a layer of water on top of the mixture to facilitate the separation of IDL and VLDL subgroups;
after the spinning step, storing the sample in the centrifuge tube in a substantially vertical orientation for a relatively short period of time and at a low temperature sufficient to stabilize the sample;
a short period of time after the storing step, extracting the contents of the centrifuge tube with a plunger device having a hole in a center of the plunger; and
pushing the plunger contents into a fluorescence detector and pumping the last amount with an HPLC pump, where the detector is calibrated and its setting adjusted to emission and absorbance wavelengths of the dye to obtain lipoprotein subgroup data.
